(19) United States
(12) Patent Application Publication
(10) Pub. No.: US 2012/0300274 A1
(43) Pub. Date: Nov. 29, 2012

(54) FLOATING VIRTUAL HOLOGRAM DISPLAY APPARATUS

(75) Inventor: CHIH-HSIUNG LIN, New Taipei City (TW)

(73) Assignee: Era Optoelectronics Inc., New Taipei City (TW)

(21) Appl. No.: 13/244,453

(22) Filed: Sep. 24, 2011

(30) Foreign Application Priority Data
May 23, 2011 (TW) 100117942

(51) Int. Cl. G03H 1/08; G03H 1/26; G03H 1/22

(52) U.S. Cl. 359/9; 359/32; 359/22

(57) ABSTRACT

A floating virtual hologram display apparatus, includes a scanning mechanism, a diffractive optical element and a reconstruction light source thereof. After a light beam emitted from the reconstruction light source passes through the diffractive optical element (DOE), and is diffracted by the DOE, a hologram beam spot will be displayed in front of the diffractive optical element; a floating virtual hologram is displayed after a position of the hologram beam spot is scanned and altered by the scanning mechanism; the floating virtual hologram being allowed to display a variable virtual image by controlling the reconstruction light source to emit bright, dark and different color of light corresponding to an image through the image signal processing unit.

### BACKGROUND OF THE INVENTION

1. Field of the Invention

The present invention relates to a display apparatus, and more particularly to a floating display apparatus capable being used as a screen.

2. Description of Related Art

Taiwan publishing patent NO. 200951771 discloses an apparatus with a virtue touch screen, comprising a screen, an optical mechanism, and a detection module, where the optical mechanism has at least one optical lens. The picture on the screen is formed into a corresponding virtual screen image in a space through the optical mechanism by means of optical imaging principle. The detection module is used to detect whether a user touches the virtual screen image or not, detect and analyze the position of a contact position with the virtual screen, and transfer the position to a contact position with the screen corresponding thereto and signal commands so that the user can operate the digital contents displayed on the virtue screen with a touch control mode, thereby achieving the effect of operating the screen substantially instead of touching it directly. The above-mentioned Taiwan published patent still need use a general screen to provide the images needed for the virtual screen, and a traditional screen cannot be saved cannot be omitted to reduce the cost.

Referring to FIG. 1, a transparent diffractive optical element (DOE) 1 available in the market is made by using a light source to illuminate a body and a photosensitive substrate, and then forming interference fringes corresponding to the light emitted from the light source and the light reflected by the body on the substrate. When a reconstruction light source 2, which is the light source used while the DOE 1 is fabricated, is used to illuminate the DOE 1 on one face thereof, and a virtual hologram 3 corresponding to the body and floating in the air is then displayed at a position outside another face of the DOE 1 with a proper distance from it. But, the DOE 1 cannot be used to display a moving hologram floating in the air currently.

Referring to FIG. 2, a MEMS (Micro Electro Mechanical System) scanning mechanism made by combining a MEMS 41 with a micro scanning mirror (MSM) 42 is now available in the market. When a light beam corresponding to a fixed or moving image is emitted from a light source 43 and then projected on the MEM 42, the MEM scans it from left to right and from up to down, and projects it to a scanning surface 40 such that a corresponding image can then be displayed. But, the MSM projector cannot project a floating moving hologram currently.

### SUMMARY OF THE INVENTION

To improve conventional floating hologram display apparatuses, and allow a moving floating virtual hologram to be displayed, the present invention is proposed.

The main object of the present invention is to provide a floating virtual hologram display apparatus, including a scanning mechanism, a DOE, and a reconstruction light source, utilizing the reconstruction light source to emit a light beam corresponding to an image; the light beam passes through the DOE onto a scanning mirror of the scanning mechanism to display a floating virtual hologram like a floating moving screen.

Another object of the present invention is to provide a floating virtual hologram display apparatus, utilizing a DOE and a plurality of reconstruction light sources corresponding to it. A plurality of hologram beam spots are displayed in front of the DOE after light beams emitted from the plurality of reconstruction light sources pass through the DOE, and are then diffracted by the DOE; a floating three-dimensional virtual hologram is displayed after the positions of said plurality of hologram beam spots are scanned and altered by a scanning mechanism.

### BRIEF DESCRIPTION OF THE DRAWINGS

The present invention can be more fully understood by reference to the following description and accompanying drawings, in which:

FIG. 1 is a schematic view of a conventional DOE, displaying a floating virtual hologram;

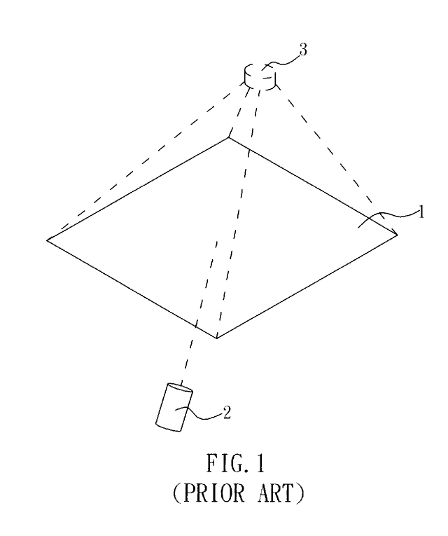

FIG. 2 is a schematic view of a conventional MSM projector, projecting an image;

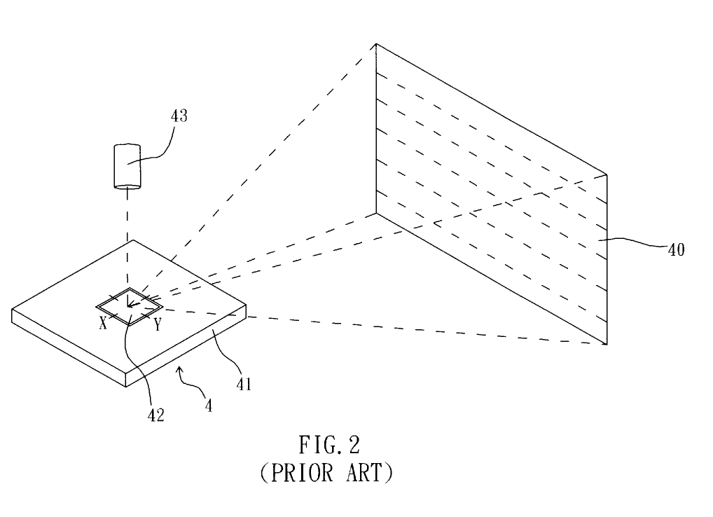

FIG. 3 is a schematic view of a floating virtual hologram display apparatus of a first preferred embodiment according to the present invention;

FIG. 4 is a schematic view of a floating virtual hologram display apparatus of a second preferred embodiment according to the present invention;

FIG. 5 is a schematic view of a floating virtual hologram display apparatus of a third preferred embodiment according to the present invention;

FIG. 6 is a schematic view of a floating virtual hologram display apparatus of a fourth preferred embodiment according to the present invention; and

FIG. 7 is a schematic view of a floating virtual hologram display apparatus of a fifth preferred embodiment according to the present invention.

### DETAILED DESCRIPTION OF THE PREFERRED EMBODIMENTS

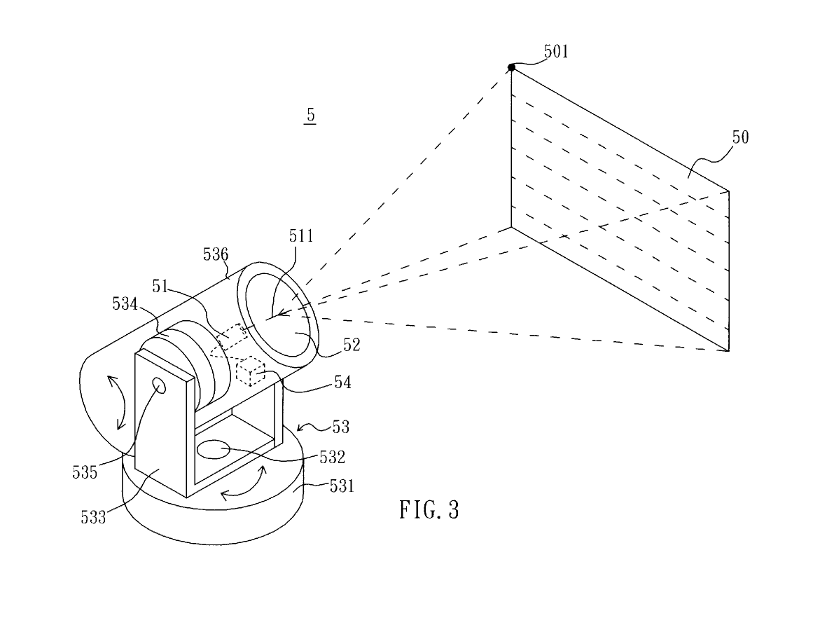

Referring to FIG. 3, a floating virtual hologram display apparatus 5 of a first preferred embodiment according to the present invention includes a reconstruction light source 51, a DOE 52, a scanning mechanism 53 and an image signal processing unit 54, where the reconstruction light source 51 is electrically connected to the image signal processing unit 54. The scanning mechanism 53 is a conventional structure, installed with a first motor 531, a first shaft (X-axis) 532, a first bracket 533, a second motor 534, a second shaft (Y-axis) 535 and a second bracket 536, where the first bracket 533 is respectively coupled to the first shaft 532 and the second motor 534, and the second shaft 535 is coupled to the second bracket 536. The first motor 531 can drive the first shaft 532 to rotate, allowing the first bracket 532 to rotate around the first shaft 532, and scan from left to right repeatedly, and the second motor 535 can drive the second shaft 535 to rotate, allowing the second bracket 536 to rotate around the second shaft 535, allowing the second bracket 536, and scan up-down repeatedly.

The reconstruction light source 51, DOE 52 and image signal processing unit 54 are respectively coupled to the second bracket 536 of the scanning mechanism 53. The scanning way of the scanning mechanism 53 is first taking the first shaft 532 as a rotating center scanning from left to right, and then taking the second shaft 535 as a rotating center rotating down-up a small angle. Thereafter, the scanning mechanism 53 takes the first shaft 532 as a rotating center again rotating from right to left, and repeats the above-mentioned procedures scanning from left to right and up to down over and over again. After a light beam 511 emitted from the reconstruction light source 51 passes through the DOE 52, and is diffracted by the DOE 52, a hologram beam spot 501 will be displayed in front of the DOE 52. A floating virtual hologram 50 is displayed in front of the DOE 52 to a human's vision through human persistence of vision after the position of the hologram beam spot 501 is scanned and altered by the scanning mechanism 53 with a scanning speed of over 24 times per second to the whole picture of the virtual hologram 50. The floating virtual hologram 50 is allowed to display a variable virtual image like a floating moving screen by controlling the reconstruction light source to emit bright, dark and different color of light corresponding to an image through the image signal processing unit 54.

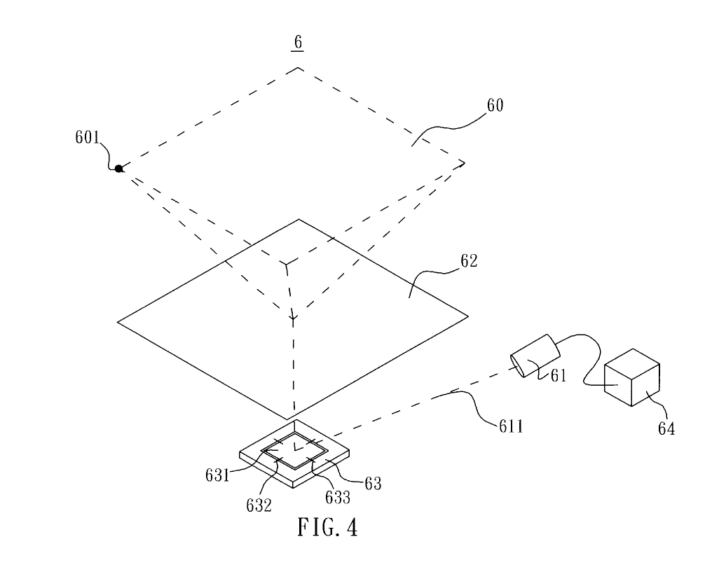

Referring to FIG. 4, a floating virtual hologram display apparatus 6 of a second preferred embodiment according to the present invention includes a reconstruction light source 61, a DOE 62, a scanning mechanism 63 and an image signal processing unit 64, where the reconstruction light source 61 is electrically connected to the image signal processing unit 64. The scanning mechanism 63 is installed with a scanning mirror 631, and the scanning way of the scanning mirror 631 is taking a first shaft (X-axis} 632 as a rotating axis scanning from left to right repeatedly, and then taking a second shaft (Y-axis) 633 as a rotating axis rotating down-up a small angle. Thereafter, the scanning mirror 631 takes the X-axis as a rotating axis rotating from right, to left, and repeats the above-mentioned procedures scanning from left to right and up to down over and over again. After a light beam 611 emitted from the reconstruction light source 61 passes through the DOE 62, and is diffracted by the DOE 62, a hologram beam spot 601 will be displayed in front of the DOE 62. A floating virtual hologram 60 is displayed in front of DOE 62 to a human's vision through human persistence of vision after the position of the hologram beam spot 601 is scanned and altered by the scanning mirror 631 with a scanning speed of over 24 times per second to the whole picture of the virtual hologram 60. The floating virtual hologram 60 is allowed to display a variable virtual image like a floating moving screen by controlling the reconstruction light source 61 to emit bright, dark and different color of light corresponding to an image through the image signal processing unit 64.

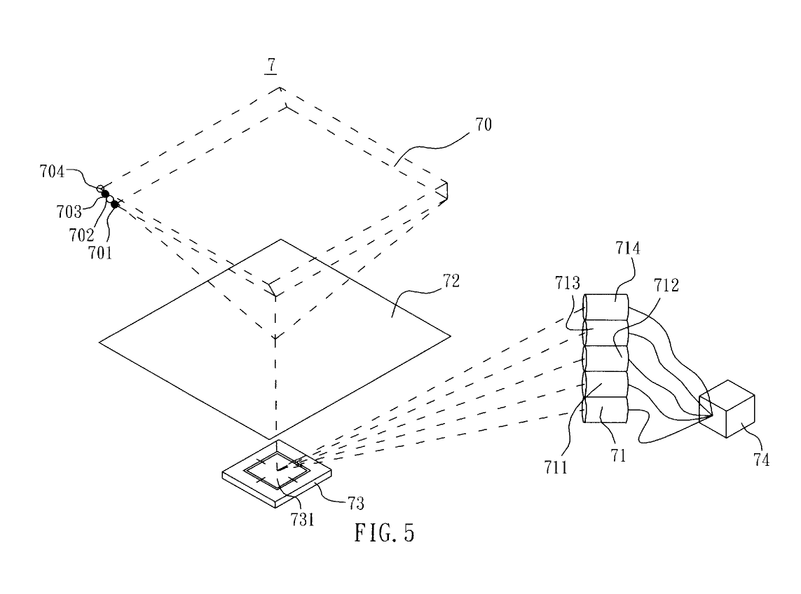

Referring to FIG. 5, a floating virtual hologram display apparatus 7 of a third preferred embodiment of the present invention includes a plurality of reconstruction light sources 711, 712, 713 and 714, a DOE 712, a scanning mechanism 73 and an image signal processing unit 74. The plurality of reconstruction light sources 711, 712, 713 and 714 are respectively electrically connected to the image signal processing unit 74, and the scanning mechanism 73 is installed with a scanning mirror 731. The present embodiment has approximately the same structure and functions as the second embodiment, except the DOE 72 of the present embodiment is operated in coordination with, the plurality of reconstruction light sources 711, 712, 713 and 714. After light beams emitted from the plurality of reconstruction light sources 711, 712, 713 and 714 pass through the DOE 72, and are diffracted by the DOE 72, a plurality of hologram beam spots 701, 702, 703 and 704 arranged in a line will be displayed in front of the DOE 72. A floating three-dimensional virtual hologram 70 is displayed in front of the DOE 72 to a human's vision through human persistence of vision after the positions of the plurality of reconstruction light sources 711, 712, 713 and 714 arranged in a line are scanned and altered by the scanning mechanism 73. The floating three-dimensional virtual hologram 70 is allowed to display a variable virtual image like a floating moving screen by controlling the plurality of reconstruction light sources 711, 712, 713 and 714 to emit bright, dark and different color of light corresponding to a three-dimensional image through the image signal processing unit 74. The present embodiment may use one multi-wavelength light source 71 stead of the plurality of reconstruction light sources 711, 712, 713 and 714, where the multi-wavelength reconstruction light source 71 is electrically connected to the image signal processing unit 74. After four wavelengths of light beams emitted respectively from the multi-wavelength reconstruction light source 71 (equivalent to four different light beams emitted respectively from the four reconstruction light sources 711, 712, 713 and 714) pass through the DOE 72, and are diffracted by the DOE 72, a plurality of hologram beam spots 701, 702, 703 and 704 arranged in a line will be displayed in front of the DOE 72.

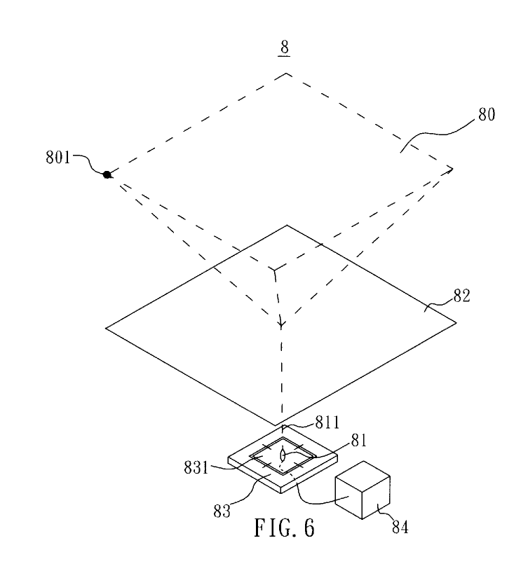

Referring to FIG. 6, a floating virtual hologram display apparatus 8 of a fourth preferred embodiment of the present invention includes a reconstruction light source 81, a DOE 812, a scanning mechanism 83 and a image signal processing unit 84. The reconstruction light source 81 is electrically connected to the image signal processing unit 84, and the scanning mechanism 83 is installed with a scanning unit 831. The present embodiment has approximately the same structure and functions as the second embodiment, except the reconstruction light source 81 of the present embodiment is attached to the scanning unit 831, and the position thereof can change with the scanning unit 831 allowing a light beam 811 projected on the DOE 82 to carry out scanning. After a light beam emitted from the reconstruction light source 81 passes through the DOE 82, and is diffracted by the DOE 82, a hologram beam spot 801 will be displayed in front of the DOE 82. A floating virtual hologram 80 is displayed in front of the DOE 82 to a human's vision through human persistence of vision after the position of the position of holograph beam spot 801 is scanned and altered. The present embodiment allows the light beam 811 emitted from the reconstruction light source 81 to be scanned by the scanning unit 831, for example, scanned by means of the scanning way of the scanning mirror 631 in FIG. 4 mentioned above, to change the position of the DOE 802 on which the light beam 811 is protected to scan and alter the position of the hologram beam spot 801. The floating virtual hologram 80 is allowed to display a variable virtual image like a floating moving screen by controlling the reconstruction light source 81 to emit bright, dark and different color of light, corresponding to an image through the image signal processing unit 84.

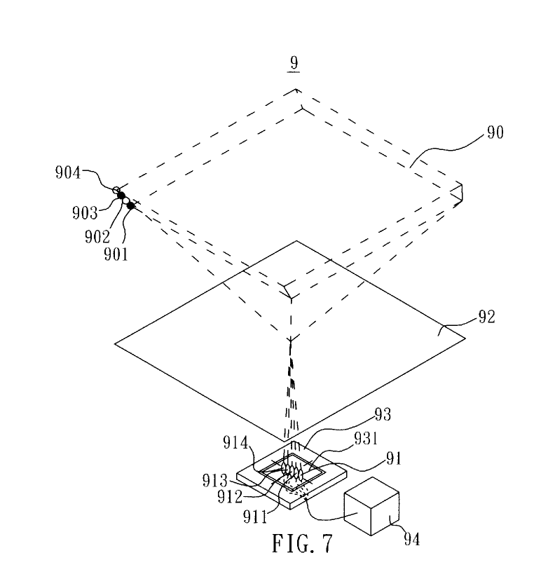

Referring to FIG. 7, a floating virtual hologram display apparatus 9 of a fifth preferred embodiment of the present invention includes a plurality of reconstruction light sources 911, 912, 913 and 914, a DOE 92, and a scanning mechanism 93, an image signal processing unit 94, where the plurality of reconstruction light sources 911, 912, 913 and 914 are respectively electrically connected to the image signal processing unit 94, the scanning mechanism 93 is installed with a scanning unit 931, and the plurality of reconstruction light source 911, 912, 913 and 914 are respectively attached to the scanning unit 931 such that the positions of them can be changed with the scanning unit 931, allowing the light projected on the DOE 92 to carry out scanning. The present embodiment has approximately the same structure and functions as the fourth embodiment, except the DOE 92 is operated in coordination with the plurality of reconstruction light sources 911, 912, 913 and 914 in the present embodiment. After light beams emitted from the plurality of reconstruction light sources 911, 912, 913 and 914 pass through the DOE 92, and are diffracted by the DOE 92, a plurality of hologram beam spots 901, 902, 903 and 904 arranged in a line will be displayed in front of the DOE 92. A three-dimensional floating virtual hologram 90 is displayed in front of the DOE 92 to a human's vision through human persistence of vision after the positions of the plurality of hologram beam spots 901, 902, 903 and 904 arranged in a line are scanned and altered. The present embodiment allows the light beams emitted from the plurality of reconstruction light sources 911, 912, 913 and 914 to be scanned by the scanning unit 931, for example, scanned by means of the scanning way of the scanning mirror 631 in FIG. 4 mentioned above, to change the positions of the DOE 802 on which the light beams are projected to scan and alter the positions of the plurality of hologram beam spots 901, 902, 903 and 904. The three-dimensional floating virtual hologram 90 is allowed to display a three-dimensional variable virtual image by controlling the plurality of reconstruction light sources 911, 912, 913 and 914 to emit bright, dark and different color of light corresponding to a three-dimensional image through the image signal processing unit 94. The present embodiment may use one multi-wavelength light source 91 stead of the plurality of reconstruction light sources 911, 912, 913 and 914, where the multi-wavelength reconstruction light source 91 is electrically connected to the image signal processing unit 94. After four wavelengths of light beams emitted respectively from the multi-wavelength reconstruction light source 91 (equivalent to four different light beams emitted respectively from the four reconstruction light sources 911, 912, 913 and 914) pass through the DOE 92, and are diffracted by the DOE 92, a plurality of hologram beam spots 901, 902, 903 and 904 arranged in a line will be displayed in front of the DOE 92.

The scanning mechanism of each embodiment according to the present invention mentioned above may be a conventional MEMS (Micro Electro Mechanical System) scanning mechanism.

In each embodiment of the present embodiment, the reconstruction light source may be a LED (light emitting diode) or a laser irradiation device, and the DOE may be other LCD (liquid crystal device capable of forming diffraction fringes or an OLED (Organic Electroluminesence Display).

The floating virtual hologram display apparatus of the present invention further improves a floating display apparatus, and has a function of displaying floating moving virtual hologram. Furthermore, it utilizes the reconstruction light source to emit a light beam corresponding to an image; the light beam passes through the DOE and is then diffracted by the DOE to form a hologram beam spot in front of the DOE; a floating virtual hologram corresponding to the image like a floating moving screen after the position of the hologram beam spot is scanned and altered by the scanning mechanism. Besides, it utilize one DOE and a plurality of reconstruction light sources corresponding thereto; light beams emitted from the plurality of reconstruction light sources pass through the DOE, and are then diffracted by the DOE to display a plurality of hologram beam spots in front of the DOE; a floating three-dimensional virtual hologram is displayed after the positions of the plurality of hologram beam spots are scanned and altered by the scanning mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A floating virtual hologram display apparatus, comprising:
a diffractive optical element;
at least one reconstruction light source, being a reconstruction light source of said diffractive optical element; and
a scanning mechanism;
wherein, after a light beam emitted from said reconstruction light source passes through said diffractive optical element, and is diffracted by said diffractive optical element, a hologram beam spot will be displayed in front of said diffractive optical element;
a floating virtual hologram is displayed after a position of said hologram beam spot is scanned and altered by said scanning mechanism.

2. The floating virtual hologram display apparatus according to claim 1, wherein said scanning mechanism is installed with a first motor, a first shaft, a first bracket, a second motor, a second shaft and a second bracket; said first bracket is respectively coupled to said first shaft and said second motor, said second shaft is coupled to said second bracket; said first bracket is allowed to take said first shaft as a rotating center scanning from left to right repeatedly when said first motor drives said first shaft to rotate; said second bracket is allowed to take said second shaft as a rotating center scanning up-down repeatedly when said second motor drives said said optical diffractive element and said image signal processing unit are respectively coupled to said second bracket.

3. The floating virtual hologram display apparatus according to claim 2, comprising a plurality of reconstruction light sources; light beams respectively emitted from said plurality of reconstruction light sources being respectively projected on said diffractive optical element, allowing a plurality of hologram beam spots arranged in a line to be displayed in front of said diffractive optical element, a three-dimensional virtual hologram is displayed in front of said diffractive optical element after positions of said plurality of hologram beam spots arranged in a line are scanned and altered by said scanning mechanism.

4. The floating virtual hologram display apparatus according to claim 1, wherein said scanning mechanism is configured with a scanning mirror; a light beam emitted from said reconstruction light source is projected on said scanning mirror, and then reflected to said diffractive optical element by said scanning mirror.

5. The floating virtual hologram display apparatus according to claim 4, comprising a plurality of reconstruction light sources; light beams respectively emitted from said plurality of reconstruction light sources being respectively reflected to said diffractive optical element by said scanning mirror, allowing a plurality of hologram beam spots arranged in a line to be displayed in front of said diffractive optical element, a three-dimensional virtual hologram is displayed in front of said diffractive optical element after positions of said plurality of hologram beam spots arranged in a line are scanned and altered by said scanning mechanism.

6. The floating virtual hologram display apparatus according to claim 1, wherein said scanning mechanism is configured with a scanning unit; said reconstruction light source is attached to said scanning unit to change a position with said scanning unit, allowing said light beam projected on said diffractive optical element to carry out scanning.

7. The floating virtual hologram display apparatus according to claim 6, comprising a plurality of reconstruction light sources; a plurality of hologram beam spots arranged in a line being displayed in front of said diffractive optical element after light beams respectively emitted from said plurality of reconstruction optical element pass through said diffractive optical element and are diffracted by said diffractive optical element; said plurality of reconstruction light sources being respectively attached to said scanning unit to change positions with said scanning unit, allowing said light beams projected on said diffractive optical element to carry out scanning, and a three-dimensional virtual hologram is displayed in front of said diffractive optical element.

8. The floating virtual hologram display apparatus according to claim 1, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit.

9. The floating virtual hologram display apparatus according to claim 3, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit.

10. The floating virtual hologram display apparatus according to claim 8, wherein said reconstruction light source is a multi-wavelength reconstruction light source; said multi-wavelength light source emit light with a variety of wavelengths, allowing a plurality of hologram beam spots arranged in a line to be displayed in front of said diffractive optical element, a three-dimensional virtual hologram is displayed in front of said scanning mirror after positions of said plurality of hologram beam spots arranged in a line are scanned and altered.

11. The floating virtual hologram display apparatus according to claim 1, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit; wherein said scanning mechanism is a micro electro mechanical system scanning mechanism, said reconstruction light source is one selected from a light emitting diode and laser irradiation device, and said diffractive optical element, is one selected from a liquid crystal display and an organic electroluminescence display generating diffraction fringes.

12. The floating virtual hologram display apparatus according to claim 5, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit; wherein said scanning mechanism is a micro electro mechanical system scanning mechanism, said reconstruction light source is one selected from a light emitting diode and laser irradiation device, and said diffractive optical element is one selected from a liquid crystal display and an organic electroluminescence display generating diffraction fringes.

13. The floating virtual hologram display apparatus according to claim 11, wherein said reconstruction light source is a multi-wavelength reconstruction light source; said multi-wavelength light source emit light with a variety of wavelengths, allowing a plurality of hologram beam spots arranged in a line to be displayed in front of said diffractive optical element, a three-dimensional virtual hologram is displayed in front of said scanning mirror after positions of said plurality of hologram beam spots arranged in a line are scanned and altered.

14. The floating virtual hologram display apparatus according to claim 2, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit.

15. The floating virtual hologram display apparatus according to claim 5, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit.

16. The floating virtual hologram display apparatus according to claim 7, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit.

17. The floating virtual hologram display apparatus according to claim 4, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit; wherein said scanning mechanism is a micro electro mechanical system scanning mechanism, said reconstruction light source is one selected from a light emitting diode and laser irradiation device, and said diffractive optical element is one selected from a liquid crystal display and an organic electroluminescence display generating diffraction fringes.

18. The floating virtual hologram display apparatus according to claim 6, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit; wherein said scanning mechanism is a micro electro mechanical system scanning mechanism, said reconstruction light source is one selected from a light emitting diode and laser irradiation device, and said diffractive optical element is one selected from a liquid crystal display and an organic electroluminescence display generating diffraction fringes.

19. The floating virtual hologram display apparatus according to claim 7, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit; wherein said scanning mechanism is a micro electro mechanical system scanning mechanism, said reconstruction light source is one selected from a light emitting diode and laser irradiation device, and said diffractive optical element is one selected from a liquid crystal display and an organic electroluminescence display generating diffraction fringes.
